(19) United States
(12) Patent Application Publication
(10) Pub. No.: US 2017/0052537 A1
(43) Pub. Date: Feb. 23, 2017

(54) System and Method for Control of Autonomous Vehicle by Mobile Device

(71) Applicant: Robert Valentin Salinas, Cedar Park, TX (US)

(72) Inventor: Robert Valentin Salinas, Cedar Park, TX (US)

(21) Appl. No.: 14/829,591

(22) Filed: Aug. 18, 2015

(51) Int. Cl. G05D 1/00; H04L 29/08; G05D 1/02; H04W 4/20

(52) U.S. Cl. CPC G05D 1/0016; H04W 4/20; H04L 67/10; G05D 1/0022; G05D 1/0278; H04W 84/042

(57) ABSTRACT

The present invention relates to a software program in the form of a mobile application that allows the user to control an autonomous vehicle (or driverless vehicle, terms used here interchangeably) by use of a mobile device utilizing cloud servers. The effect of the use of this software program is to allow users to manipulate a motor vehicle's computer, such as locking and unlocking the car door, rolling up and down the car window's, and manipulating the car's audio, for example, all done utilizing cloud servers. By utilizing cloud servers instead of the currently utilized Bluetooth technology, the user may control a vehicle from far away, a distance far enough that radio waves cannot be used as a mean of communicating between the mobile device and the vehicle.

### DETAILED DESCRIPTION OF THE PREFERRED EMBODIMENT

The present invention is a software program in the form of a mobile application that allows the user to control an autonomous vehicle (or driverless vehicle, terms used here interchangeably) by use of a mobile device utilizing cloud servers. Currently, there are mobile applications that allow users to manipulate a motor vehicle's computer, such as locking and unlocking the car door, rolling up and down the car window's, and manipulating the car's audio, for example, which are all done utilizing Bluetooth technology. Bluetooth technology utilizes radio waves to transmit information. Because radio waves are used in this method, the user can only control the vehicle from a short distance, or the distance the radio wave can travel without interruption. On the other hand, the user may want to control a vehicle from far away, a distance far enough that radio waves cannot be used as a mean of communicating between the mobile device and the vehicle. Currently, there are no mobile applications or software programs that specifically allow the user to control an autonomous vehicle from a remote location. Allowing the user to control an autonomous vehicle from a remote location using a mobile device will keep the user from having to walk to their vehicle in order to control any of the setting connected to the vehicle's onboard computer. The software program would utilize a cloud server in order to remotely connect to and control the autonomous vehicle's onboard computer; this would be accomplished by utilizing the API of the vehicle's manufacturer. The cloud server can be accessed through the use of a 3G network, 4G network, LTE network, wifi networks, or other similar networks. Further, allowing the user to control an autonomous vehicle from a remote location using a mobile device will keep the user from having to walk to their vehicle, find a ride from a friend to get to their vehicle, or take a taxi to retrieve their vehicle from where ever it may be parked. Using the car's GPS in conjunction with the mobile device's GPS, the autonomous driverless vehicle will be able to make its way to the user's desired location.

Currently on the market, and available to the public as early as next year, there are autonomous driverless vehicles, specifically used by companies to map the earth. In the near future, the public will utilize these driverless motor vehicles for personal use. Additionally, the aforementioned motor vehicles are already equipped with GPS navigation systems.

Specifically, the present invention uses a software program in the form of a mobile application that utilizes cloud servers, and not radio waves as currently being utilized, to allow the user to control an autonomous vehicle's onboard computer from a far distance through the use of a mobile device. The cloud server can be accessed through the use of a 3G network, 4G network, LTE network, wifi networks, or other similar networks.

While the invention has been described with reference to the preferred embodiment thereof, it will be appreciated by those of ordinary skill in the art that modifications can be made to the structure and elements of the invention without departing from the spirit and scope of the invention as a whole.

What is claimed is:

1. A software program in the form of a mobile application that allows the user to remotely control an autonomous vehicle using a mobile device through use of cloud servers and the vehicle's onboard computer.

2. A software program in the form of a mobile application that allows the user to remotely contact an autonomous vehicle and request the autonomous vehicle be brought to the user's desired location using a mobile device through use of cloud servers and the vehicle's onboard computer.

3. The software program of claim 1, in which the cloud servers are accessed through the use of a 3G network, 4G network, LTE network, wifi network, or other similar networks.

4. The software program of claim 2, in which the cloud servers are accessed through the use of a 3G network, 4G network, LTE network, wifi network, or other similar networks.
